(19) United States
(12) Patent Application Publication
(10) Pub. No.: US 2011/0292159 A1
(43) Pub. Date: Dec. 1, 2011

(54) PRINTING MACHINE AND METHOD FOR PRINTING A SUBSTRATE

(75) Inventors: Frank Kleine Jäger, Bad Durkheim (DE); Jürgen Kaczun, Wachenheim (DE); Udo Lehmann, Bickenbach (DE)

(73) Assignee: BASF SE, Ludwigshafen (DE)

(21) Appl. No.: 13/140,544

(22) PCT Filed: Dec. 14, 2009
(86) PCT No.: PCT/EP2009/067020

§ 371 Date: Aug. 19, 2011

(30) Foreign Application Priority Data
Dec. 17, 2008 (EP) 08171931.2

(51) Int. Cl. B41J 2/435

(52) U.S. Cl. 347/262

(57) ABSTRACT

The invention relates to a printing machine, comprising a flexible carrier (3) which is coated with an ink to be printed, and to a device for the introduction of energy (11) into the ink, the device for the introduction of energy (11) being arranged in such a way that the energy can be introduced in a printing area (9) on the side facing away from the ink, so that ink is transferred from the carrier (3) to a substrate (7) to be printed. In the printing area there is arranged a tensioning device (13), with which the flexible carrier (3) is tensioned in the area in which the energy is introduced, in order to obtain a smooth surface. The invention further relates to a method for printing a substrate (7), in which an ink is applied to a flexible carrier (3) and the ink is transferred from the flexible carrier (3) to the substrate (7) in accordance with a predefined pattern, by energy being introduced into the ink through the flexible carrier (3), some of the ink evaporating in the area of action of the energy and, as a result, a drop of ink being thrown onto the substrate (7) to be printed. The flexible carrier (3) is tensioned in the area in which the energy is introduced into the ink.

The invention relates to a printing machine, comprising a flexible carrier which is coated with an ink to be printed, and to a device for the introduction of energy into the ink, the device for the introduction of energy being arranged in such a way that the energy can be introduced in a printing area on the side facing away from the ink, so that ink is transferred from the carrier to a substrate to be printed. The invention further relates to a method for printing a substrate in which, in a first step, ink is applied to a flexible carrier and, in a second step, the ink is transferred from the flexible carrier to the substrate in accordance with a predefined pattern, by energy being introduced into the ink through the flexible carrier, a solvent contained in the ink evaporating in the area of action of the ink and, as a result, a drop of ink being thrown onto the substrate to be printed.

A method for printing a substrate in which ink drops are thrown onto a substrate to be printed from a carrier coated with an ink is known, for example from U.S. Pat. No. 6,241,344. In order to transfer the ink, at the position at which the substrate is to be printed, energy is introduced through the carrier into the ink on the carrier. As a result, some of the ink evaporates, so that it is separated from the carrier. As a result of the pressure of the evaporating ink, the drop of ink separated in this way is thrown onto the substrate. By means of directed introduction of the energy, in this way the ink can be transferred to the substrate in accordance with a pattern to be printed. The energy needed to transfer the ink is introduced, for example, by a laser. The carrier to which the ink is applied is, for example, a circulating belt, onto which ink is applied with the aid of an application device before the printing area. The laser is located in the interior of the circulating belt, so that the laser acts on the carrier on the side facing away from the ink.

A corresponding printing machine is further known, for example also from U.S. Pat. No. 5,021,808. Here, too, the ink from a storage container is applied to a circulating belt by an application device, there being a laser within the circulating belt, by means of which the ink is evaporated at predefined positions and in this way is thrown onto the substrate to be printed. In this case, the belt is fabricated from a material that is transparent to the laser. In order to evaporate the ink specifically, it is possible for the circulating belt to be coated with an absorption layer, in which the laser light is absorbed and converted into heat and thus evaporates the ink at the position at which the laser acts.

The application of the ink to the flexible carrier is in this case generally carried out by roll-based units, one roll dipping into a storage container containing ink, and the ink being transferred to the flexible carrier with the aid of the roll.

The disadvantage of the known printing devices is that the printing quality depends to a great extent on the homogeneity of the conditions involved in the process. For example, even extremely small local differences directly at the points of input of the energy can lead to an impairment of the quality of the printed result. Such differences are, for example, differences in the thickness of the ink application and also distortion waves which can arise in the flexible carrier. In addition, inhomogeneities in the flexible carrier can lead to a poor printed image.

It is an object of the present invention to provide a printing machine and a method for printing a substrate in which fluctuations in the printing quality as a result of inhomogeneities in the flexible carrier are avoided.

The object is achieved by a printing machine, comprising a flexible carrier which is coated with an ink to be printed, and also a device for the introduction of energy into the ink, the device for the introduction of energy being arranged in such a way that the energy can be introduced in a printing area on the side facing away from the ink, so that ink is transferred from the carrier to a substrate to be printed. In the printing area there is arranged a tensioning device, with which the flexible carrier is tensioned in the area in which the energy is introduced, in order to obtain a smooth surface.

Furthermore, the object is achieved by a method for printing a substrate which comprises the following steps:
a) Applying an ink to a flexible carrier,
b) Transferring the ink from the flexible carrier to the substrate in accordance with a predefined pattern, by energy being introduced into the ink through the flexible carrier, some of the ink evaporating in the area of action of the energy and, as a result, a drop of ink being thrown onto the substrate to be printed.

According to the invention, the flexible carrier is tensioned in the area in which the energy is introduced into the ink.

As a result of the tensioning of the flexible carrier, any distortion waves which occur in the flexible carrier are smoothed out. In this way, a homogeneous surface can be achieved in the printing area. In this case, printing area designates the area in which energy is introduced into the ink, some of the ink is evaporated and, as a result, a drop of ink is transferred to the substrate to be printed. As a result of the tensioning of the flexible carrier, the printing gap, which means the gap between the flexible carrier with the ink applied thereto and the substrate to be printed, is made uniform. Different gap widths which, for example, are produced by waves in the flexible carrier, are thus prevented and the printed image is improved as a result. In one embodiment, the printing gap can be adjusted by displacing the tensioning device in the direction of the substrate to be printed or away from the latter.

As a result of the tensioning of the flexible carrier and the flat surface produced as a result, it is ensured that the drop of ink which is to leave the flexible substrate and which is thrown onto the substrate to be printed follows a targeted path which runs substantially at right angles to the direction of the flexible carrier. In this way, a clean printed image can be achieved.

Furthermore, in order to achieve a homogeneous printed image, it is advantageous if the substrate to be printed and the flexible carrier coated with ink in the printing area have a printing gap in the range from 0 to 2 mm, in particular in the range from 0.01 to 1 mm. The smaller the printing gap between the flexible carrier and the substrate to be printed, the less the drop widens as it strikes the substrate to be printed, and the more uniform the printed image remains. However, care must likewise be taken that the substrate to be printed does not touch the flexible carrier coated with ink, in order that ink is not transferred from the flexible carrier to the substrate to be printed at undesired points.

In order to achieve a clean printed image, the energy is preferably introduced into the ink through the flexible carrier in a focused manner. The size of the point onto which the energy to be introduced is focused in this case corresponds to the size of the dot to be transferred, depending on the substrate. In general, dots to be transferred have a diameter in the range from about 20 μm to about 200 μm. However, the size of the dot to be transferred can vary, depending on the substrate to be printed and the printed result produced therewith. For instance, it is possible, in particular during the production of printed circuit boards, to choose a larger focus. On the other hand, in the case of printed products in which a text is represented, small printing dots are generally preferred in order to produce a clear text image. In addition, when printing images and graphics, it is advantageous to print the smallest possible dots in order to produce a clear image.

The flexible carrier used in the printing machine, which is coated with the ink to be printed, is preferably configured in the form of a belt. The flexible carrier is particularly preferably a thin sheet. In this case, the thickness of the flexible carrier preferably lies in the range from 1 to about 500 μm, in particular in the range from 10 to 200 μm. It is advantageous to implement the flexible carrier with a low thickness if possible, in order that the energy introduced through the carrier is not scattered in the carrier, and thus a clean printed image is produced. For example, polymer films that are transparent to the energy used are suitable as a material.

In one embodiment of the printing machine, the flexible carrier is stored in a suitable device. To this end, it is possible, for example, for the carrier which is coated with ink to be wound up into a roll. For the purpose of printing, the carrier coated with ink is then unwound and guided over the printing area, in which, with the aid of the laser, ink is transferred from the carrier to the substrate to be printed. The carrier is then wound up onto a roll again, for example, which can then be sent to disposal. However, it is preferred for the flexible carrier to be formed as a circulating belt. In this case, ink is applied to the flexible carrier by a suitable application device before said carrier reaches the printing position, which means the point at which the ink is transferred from the carrier to the substrate to be printed with the aid of the input of energy. After the printing operation, some of the ink has been transferred from the carrier to the substrate. As a result, there is no longer any homogeneous film of ink on the carrier. For a subsequent printing operation, it is therefore necessary to coat the carrier with ink again. This is carried out during the next passage past the appropriate position on the ink application device. In order to avoid ink drying on the flexible carrier and in order in each case to produce a uniform layer of ink on the carrier, it is advantageous to remove the ink on the carrier first before a subsequent application of ink to the carrier. The removal of the ink can be carried out, for example, with the aid of a roller or a doctor. If a roller is used for the removal of the ink, then it is possible to use the same roller with which the ink is also applied to the carrier. To this end, it is advantageous if the rotational movement of the roller is opposed to the movement of the flexible carrier. The ink removed from the flexible carrier can then be fed to the ink supply again. If a roller is provided to remove the ink, it is of course also alternatively possible for one roller to be provided for the removal of the ink and one roller for the application of ink.

If the ink is to be removed from the flexible carrier by a doctor, then any desired doctor known to those skilled in the art can be used.

In order to avoid the flexible carrier being damaged during the application of the ink or during the removal of the ink, it is preferable for the flexible carrier to be pressed with the aid of a backing roll against the applicator roll with which the ink is applied to the carrier or the roller with which the ink is removed from the carrier or the doctor with which the ink is removed from the carrier. In this case, the back pressure is adjusted in such a way that the ink is removed substantially completely but no damage to the flexible carrier occurs.

In order to tension the flexible carrier, the tensioning device in a first embodiment comprises at least two guide elements, which are arranged on the two sides of the device for the introduction of energy. In this case, in the transport direction of the flexible carrier, at least one guide element is arranged before the device for the introduction of energy and at least one guide element is arranged after the device for the introduction of energy. By means of the guide elements, the flexible carrier is tensioned precisely in the area in which the energy is introduced and the ink is transferred to the substrate to be printed. Here, the spacing of the guide elements is preferably chosen such that said spacing is at most twice as wide as the device for the introduction of energy. If the energy is introduced with a laser, it is even possible for the spacing of the guide elements to correspond to the width of the laser beam used, so that the latter can be guided through between the guide elements without interference. As a result of the short spacing between the guide elements, even a small force is sufficient to tension the flexible carrier in order to achieve a flat surface of the flexible carrier in the printing area.

As the guide elements along which the flexible carrier is guided in order to tension the latter, it is possible to use any desired elements that are known to those skilled in the art and are suitable. Suitable guide elements are, for example, tensioning rollers, air cushions or non-moving rods. If tensioning rollers are used as guide elements, these can rotate at a circumferential speed which corresponds to the speed of the flexible carrier. Alternatively, however, it is also possible, in particular in order to achieve improved tensioning and therefore a flat surface of the flexible carrier, for the tensioning roller which, in the transport direction of the flexible carrier, is arranged after the device for the introduction of energy to have a higher circumferential speed than the speed of the flexible carrier or, alternatively, for the tensioning roller which, in the direction of movement of the flexible carrier, is located before the device for the introduction of energy to move at a lower circumferential speed than the speed of the flexible carrier. Furthermore, it is of course also possible for both the tensioning roller before the device for the introduction of energy to run more slowly than the speed of the flexible carrier, and for the tensioning roller which is arranged after the device for the introduction of energy to run faster than the flexible carrier.

The tensioning rollers can both be provided with an individual drive in each case, or one drive is provided for both tensioning rollers. The tensioning rollers can then be connected via a gear mechanism, for example. Alternatively, it is also possible for the tensioning rollers not to be driven but for the rotational movement of the tensioning rollers to be brought about by the flexible carrier.

If, instead of tensioning rollers, use is made of non-moving rods, on which the flexible carrier runs along, then these are preferably formed without sharp edges, in particular on the surfaces on which the flexible carrier is guided along, in order not to damage the flexible carrier. Particularly suitable are rods having a circular, an oval or any other desired curved cross section which has no edges, in particular in the region in which the flexible carrier is guided. However, the rods are quite particularly preferably cylindrical, that is to say configured with a circular cross section.

In order to avoid the flexible carrier being damaged by non-moving rods, it is advantageous if the material of the surface of the non-moving rods is chosen such that this exhibits only a low coefficient of friction with respect to the material of the flexible carrier. In this way, it is possible to avoid the flexible carrier sticking too firmly to the non-moving rod used as a tensioning element. In order to obtain a sufficiently low coefficient of friction, it is possible, for example, to provide the rods with a PTFE coating. Alternatively, it is also possible to fabricate the non-moving rods from PTFE.

In one embodiment, the guide elements are fixed rigidly in their position. Only when tensioning rollers are used can a rotational movement be carried out. In this case, a radial movement of the guide elements is not possible. Alternatively, however, it is also possible, for example, to mount the guide elements such that they can be displaced radially. Depending on the flexible carrier used and on the substrate to be printed, it is possible in this case, for example, to move the guide elements in the direction of the substrate to be printed or away from the latter. In this way, for example, the gap between flexible carrier and substrate to be printed can also be adjusted. If the guide elements are mounted such that they can move, then it is also possible, for example, for the guide elements to be moved toward each other or away from each other. Suitable guides and mountings with which such movements are possible are known to those skilled in the art.

Besides tensioning rolls and non-moving rods, it is also possible to use air cushions, for example, as guide elements. In this case, it is firstly possible, for example, for a compressed air line provided with nozzle openings to be provided, from which compressed air emerges in the area in which the flexible carrier is guided. In this way, an air cushion is formed between the flexible carrier and the compressed air line. The flexible carrier can slide along the air cushion without friction. Alternatively, however, it is also possible, for example, to use air-filled cushions as a tensioning device. In this case, the cushion comprises a skin made of a flexible material which is filled with a gas. As a result of filling with the gas, the skin expands and in this way is able to tension the flexible carrier. In the area of the flexible carrier, the cushion preferably has a rounded section, for example a cylindrical section. Air or nitrogen is in particular suitable as the gas with which the cushion is filled or, alternatively, as the pressurized gas which is used to produce the air cushion.

In an alternative embodiment, the tensioning device comprises a guide element that is transparent to the energy used. In this case, the guide element that is transparent to the energy used is located directly in the printing area. This means that the guide element is positioned between the device for the introduction of energy and the flexible carrier, so that the energy with which the ink is evaporated from the carrier and is transferred to the substrate has to be guided through the guide element.

The energy which is used in order to evaporate the ink and to transfer it to the substrate to be printed is preferably a laser. The advantage of a laser is that the laser beam used can be focused onto a very small cross section. A targeted input of energy is thus possible. In order to evaporate the ink from the flexible carrier at least partly and to transfer it to the substrate, it is necessary to convert the light from the laser into heat. To this end, it is firstly possible for a suitable absorber to be contained in the ink, which absorbs the laser light and converts it into heat. Alternatively, it is also possible for the flexible carrier to be coated with an appropriate absorber or to be made from such an absorber or to contain such an absorber, which absorbs the laser light and converts it into heat. However, it is preferred for the flexible carrier to be made from a material that is transparent to the laser radiation and for the absorber which converts the laser light into heat to be contained in the ink. Suitable absorbers are, for example, carbon black, metal nitrites or metal oxides.

If the energy used, which is conducted through the guide element, is laser radiation, then it is preferred to use as a guide element a body which is transparent to laser radiation and which is formed in such a way that the penetrating laser light is not scattered. The use of a material and a body by which the laser light is not scattered avoids the laser beam being widened and thus an unclean printed image being produced. It is particularly preferred for the guide element to be formed in such a way that the energy introduced is focused at a point in the ink on the flexible carrier. To this end, it is, for example, possible to configure the guide element in the form of a lens. In order to avoid damage to the flexible carrier, in this case, however, the guide element preferably has a convex surface, over which the flexible carrier is guided.

Suitable for the material which is transparent to the energy used and from which the guide element is formed, is, for example, glass or plastics that are transparent to the energy used, for example to the laser radiation used, such as polyimides.

In particular if the energy used is focused by the guide element, it is preferable for the focal point to be located directly on the interface between the flexible carrier and the ink applied to the carrier.

Suitable as the ink which can be transferred to the substrate to be printed by the printing machine according to the invention is any desired printing ink known to those skilled in the art. The use of liquid inks is preferred. Usually, liquid inks used contain at least one solvent and color-forming solid materials, for example pigments. Alternatively, however, it is also possible for the ink, for example, to contain a solvent and electrically conductive particles dispersed in the solvent. In this case, for example a printed circuit board can be printed with the ink used. In addition, in particular when a laser is used for the input of energy, it is preferable for the ink further to contain an additive which absorbs the laser radiation and converts it into heat.

If conventional printing inks are used, then the substrate to be printed is preferably paper. However, any other desired substrate can also be printed with the device according to the invention. For instance, by using the printing machine according to the invention, paperboard or other paper products, plastics, for example plastic films, metal foils or composite films, can also be printed. Such plastic films, metal foils or composite films can be used, for example, for packaging materials. The printing machine and the method are also suitable for printing printed circuit boards. In this case, the substrate to be printed is usually any desired printed circuit board substrate known to those skilled in the art. The printed circuit board substrate can be both solid and also flexible.

Embodiments of the invention are illustrated in the drawings and will be explained in more detail in the following description.

In the drawings:

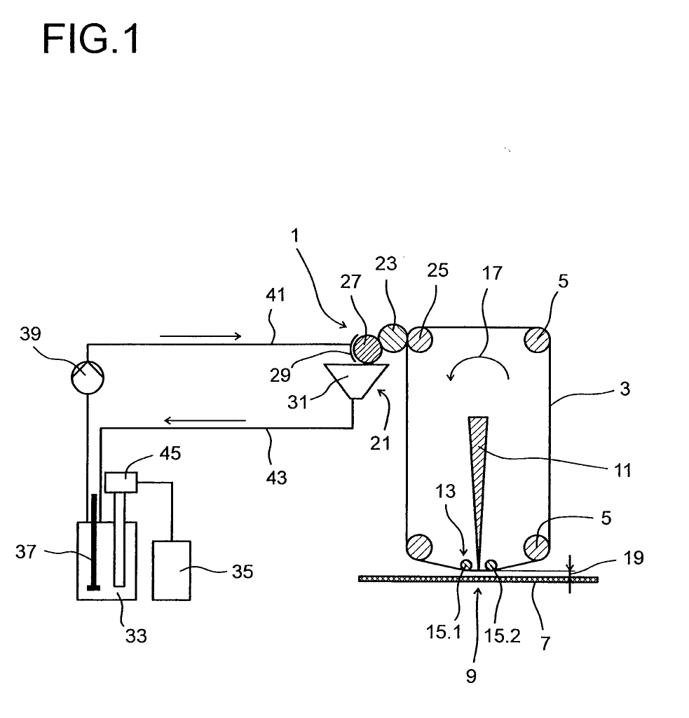

FIG. 1 shows a schematic illustration of a printing machine constructed in accordance with the invention,

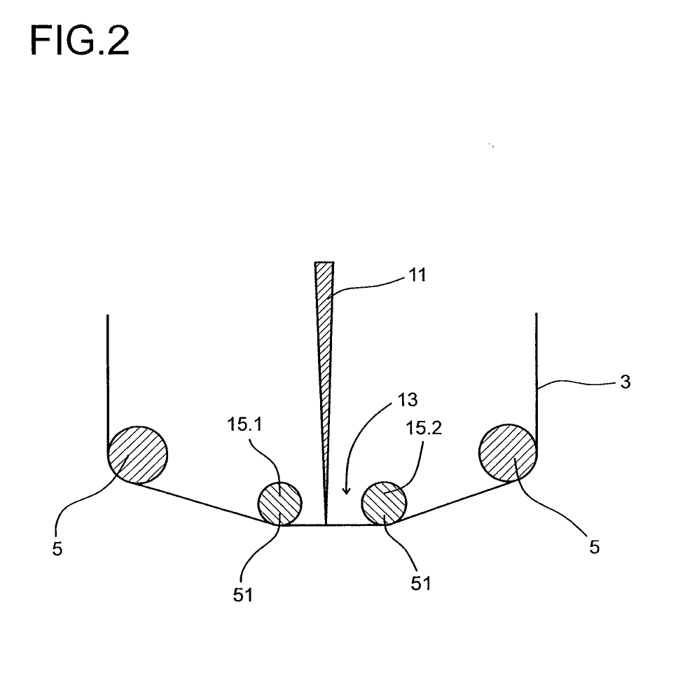

FIG. 2 shows a tensioning device having two guide elements in a first embodiment,

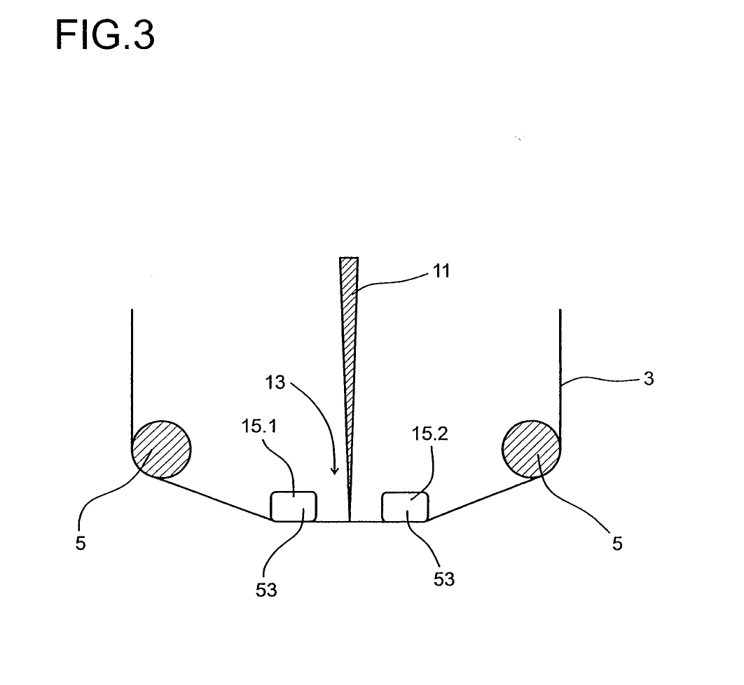

FIG. 3 shows a tensioning device having two guide elements in a second embodiment,

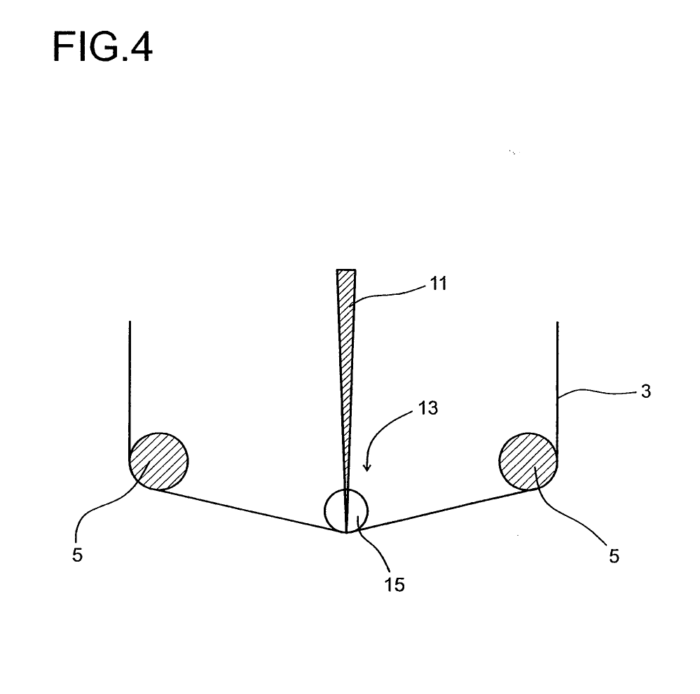

FIG. 4 shows a tensioning device having one guide element in a first embodiment,

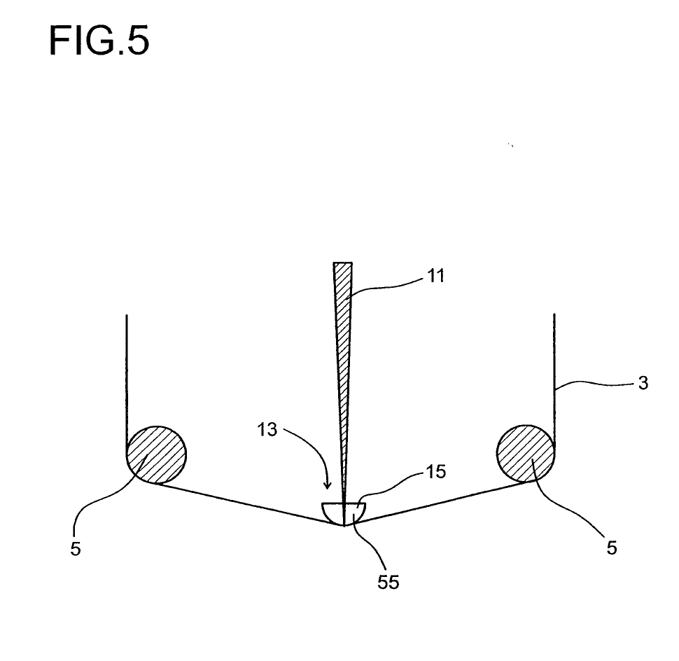

FIG. 5 shows a tensioning device having one guide element in a second embodiment.

FIG. 1 shows a schematic illustration of a printing machine constructed in accordance with the invention.

A printing machine 1 comprises a flexible carrier 3 which, in the embodiment illustrated here, is designed as an endless belt and guided around a plurality of deflection rollers 5. An ink is applied to the flexible carrier 3 in order to print a substrate 7.

To print the substrate 7, energy is introduced into the ink through the flexible carrier 3 in a printing area 9. As a result of the introduction of the energy into the ink, some of the ink evaporates, by which means a drop of ink is thrown onto the substrate 7. Suitable as the energy which is introduced into the ink is, for example, a laser 11. Suitable lasers 11 which can be used in order to introduce energy into the ink are, for example, fiber lasers, which are operated in the basic mode.

In order to improve the printed image, the printing machine 1 according to the invention further comprises a tensioning device 13. In the embodiment illustrated in FIG. 1, the tensioning device 13 comprises a first guide element 15.1 which, in the transport direction of the flexible carrier 3, which is illustrated by an arrow 17, is arranged before the device for the introduction of energy, here the laser 11, and a second guide element 15.2 which, in the transport direction 17 of the flexible carrier 3, is arranged after the device for the introduction of energy. By using the first guide element 15.1 and the second guide element 15.2, the flexible carrier 3 is tensioned in the printing area 9, in order in this way to produce a flat surface of the flexible carrier 3 in the printing area 9 and, for example, to remove waves which can occur. In this way, a homogenous printing gap 19 can be produced. This means that the printing gap 19 has a uniform height in the entire printing area 9. In this case, the printing gap 19 is the spacing between the flexible carrier 3 coated with ink and the substrate 7 to be printed.

If guide elements 15.1, 15.2 which can be displaced radially are provided, it is possible to enlarge or reduce the height of the printing gap 19 by means of radial movement of the guide elements 15.1, 15.2, by these being moved closer to the substrate to be printed or moved away from the latter. In addition, for example the width of the printing area 9 can be varied by the guide elements 15.1, 15.2 being moved toward each other or away from each other. Furthermore, it is, for example, also possible for the guide elements 15.1, 15.2 to be moved together with the device for the introduction of energy, for example the laser 11, if this can be moved therewith in the transport direction 17 of the flexible carrier 3 or counter to the transport direction 17 of the flexible carrier 3. In this way, a printing area 9 with constant dimensions can be implemented. This makes it possible to keep the printing gap 19 homogeneous and, as a result, to implement constant printing conditions and thus to improve the printed image.

The ink which is printed onto the substrate 7 in the printing area 9 is applied to the flexible carrier 3 by an application device 21. In order to ensure a uniform application of ink, the application device 21 in the embodiment illustrated here comprises an applicator roll 23, with which the ink is applied to the flexible carrier 3. The contact pressure required for the application of the ink is implemented by a backing roll 25, which at the same time serves as a deflection roller for the flexible carrier 3. With the aid of an inking roll 27, the ink is applied to the applicator roll 23. In the embodiment illustrated here, the inking roll 27 is inked by an inking plate 29. As an alternative to the inking plate 29, however, the inking roll 27 can also be coated with ink by any other desired device known to those skilled in the art. For instance, it is possible for the inking roll 27 to dip into a storage container with ink and in this way to be coated with ink. It is also possible to dispense with the inking roll 27 and to provide only an applicator roll 23. It is also possible for more than two rolls to be provided in order to apply the ink to the flexible carrier 3.

In order to collect ink dripping off the inking roll 27, a drip catcher 31 is provided in the embodiment illustrated here. Ink collected by the drip catcher 31 is led back into a storage container 33, which contains the ink. The ink contained in the storage container 33 can have solvent added to it from a solvent container 35 as needed. This is necessary, for example, in order to replace solvent that has evaporated from the storage container 33. It is also possible to use the solvent container 35 to supplement solvent, which is evaporated from the ink which has been applied to the flexible carrier 3 and has been removed from the latter again with the aid of the applicator roll 23 after the printing and led back into the storage container 33. In order to keep the ink in the storage container 33 homogeneous, a stirrer mechanism 37 is also preferably provided. Any desired stirrer mechanism known to those skilled in the art is suitable as the stirrer mechanism 37. For instance, any desired stirrer can be provided. Suitable stirrers are, for example, propeller stirrers, disk stirrers, lattice stirrers, plate stirrers, anchor-shaped stirrers or radial stirrers.

The amount of solvent which has to be metered into the storage container 33 from the solvent container 35 can be determined, for example, by means of viscosity measurement of the ink in the storage container 33. To this end, it is possible, for example, to equip the storage container 33 with a viscometer 45. Via the viscometer 45, the amount of solvent to be metered in is then determined. The viscometer 45 is preferably equipped with an automatic metering system for the solvent.

From the storage container 33, the ink is transported by a circulating pump 39 through a feed line 41 to the inking plate 29. The ink is then applied to the inking roll 27 by the inking plate 29. Excess ink drips back into the drip catcher 31 and from there runs back into the storage container 33 via a return line 43.

In order to avoid ink drying on the flexible carrier 3 and thus leading to irregularities and therefore to an impairment of the printed image, ink not applied to the substrate 7 is removed from the flexible carrier 3 again with the aid of the applicator roll 23 after printing. To this end, it is advantageous if the direction of rotation of the applicator roll 23 is opposed to the transport direction 17 of the flexible carrier 3. The ink removed from the flexible carrier 3 with the aid of the applicator roll 23 is wiped off the applicator roll 23 with the aid of the inking roll 27 and drips into the drip catcher 31, from which it is conveyed back into the storage container 33 via the return line 43.

A tensioning device 13 constructed in accordance with the invention and having two guide elements 15.1, 15.2 for adjusting the printing gap is illustrated in a first embodiment in FIG. 2.

In the embodiment illustrated in FIG. 2, the first guide element 15.1 and the second guide element 15.2 are each formed as a tensioning roller 51. The flexible carrier 3 is guided over the tensioning rollers 51 and tensioned in this way in order, for example, to remove waves from the flexible carrier 3. At the same time, with the aid of the tensioning rollers 51, the printing gap 19 between the flexible carrier 3 and the substrate 7 to be printed, not illustrated here, can be adjusted. To this end, it is advantageous if the tensioning rollers 51 can be moved radially. In this way, the tensioning rollers 51 can be moved in the direction of the substrate 7 to be printed or away from the latter.

The tensioning rollers 51 can be driven or non-driven. If the tensioning rollers 51 are driven, then it is firstly possible for these to rotate at the same circumferential speed as that at which the flexible carrier 3 moves. It is also possible, for example, for the tensioning roller 51 which, as the first guide element 15.1, is positioned in the transport direction of the flexible carrier 3 before the position of the device for the introduction of energy, that is to say the laser 11 here, to rotate more slowly than the transport speed of the flexible carrier 3, and for the tensioning roller 51 which, as the second guide element 15.2, is arranged after the device for the introduction of energy, to have a higher circumferential speed than the transport speed of the flexible carrier 3. In this way, the flexible carrier 3 is tensioned, in particular in the area between the first guide element 15.1 and the second guide element 15.2. It is also possible for only the first guide element 15.1 to have a lower circumferential speed than the transport speed of the flexible carrier 3 or for only the second guide element 15.2 to have a higher transport speed than the flexible carrier 3. Alternatively, it is also possible for the tensioning rollers 51 to be moved by the flexible carrier 3, that is to say not to have an individual drive. In yet another embodiment, the tensioning rollers 51 are mounted such that they cannot rotate. In this case, the flexible carrier 3 sides over the tensioning rollers 51. If the tensioning rollers 51 do not move or move at a different speed than the flexible carrier 3, it is preferred for the surface of the tensioning rollers 51 to be provided with a coating that sticks only slightly or does not stick or for the tensioning rollers 51 to be made from a non-sticky material.

A tensioning device 13 according to the invention having two guide elements 15.1, 15.2 in a second embodiment is illustrated in FIG. 3.

The embodiment illustrated in FIG. 3 differs from the embodiment illustrated in FIG. 2 in that the first guide element 15.1 and the second guide element 15.2 are not formed as a tensioning roller 51 but in the form of air cushions 53. The air cushions 53 used are, for example, hollow bodies made of a flexible material. In this case, the cross section can assume any desired cross section. For example, as illustrated in FIG. 3, the hollow bodies can have a rectangular cross section. However, it is, for example, also possible for these to have a circular cross section. The hollow body is filled with a gas and in this way tensions the flexible carrier 3. Depending on the filling level, the flexible carrier 3 is tensioned more highly or less highly. Suitable as a material for the sleeve of the air cushion 53 is, for example, polyethylene or polypropylene. The surface of the air cushion 53 is preferably provided with a coating which reduces the coefficient of friction and thus permits the flexible carrier 3 to slide. Alternatively, it is possible to make the sleeve of the air cushion 53 from a material which has a low coefficient of friction with respect to the material of the flexible carrier 3.

Besides an air cushion which is filled with a gas, it is alternatively also possible for example to provide a pressure pipe, which is perforated on the side of the flexible carrier 3 and thus forms an air cushion between the pressure pipe and the flexible carrier 3. This simultaneously has the advantage that the coefficient of friction between the pressure pipe and the flexible carrier 3 is virtually zero.

Apart from the embodiments illustrated in FIGS. 2 and 3, the first guide element 15.1 and the second guide element 15.2 can also be formed, for example, as rigid, non-moving rods. These can have any desired cross section, it being necessary to take care in each case that it is not sharp-edged in the area in which the flexible carrier 3 touches the guide element 15.1 or 15.2, in order to avoid damage to the flexible carrier 3.

A tensioning device 13 having a guide element 15 in a first embodiment is illustrated in FIG. 4.

As distinct from the tensioning device 13 having two guide elements 15.1, 15.2, in the case of a tensioning device 13 having one guide element 15, it is necessary for the guide element 15 to be transparent to the energy with which the ink from the flexible carrier 3 is transferred to the substrate 7. When a laser 11 is used, it is thus necessary, for example, to make the guide element 15 from a material that is transparent to the laser radiation used. Furthermore, it is necessary for the material used for the guide element 15 not to scatter the energy, for example the laser beam, in order that a clean printed image can be produced. In this case, as also in the case of the two guide elements 15.1, 15.2, the guide element 15 can have any desired cross section, the cross section being chosen in each case such that the laser beam 11 or the focused energy used is not scattered.

In FIG. 5, a tensioning device 13 having a guide element 15 in a second embodiment is illustrated.

As distinct from the embodiment illustrated in FIG. 4, in the embodiment illustrated in FIG. 5 the guide element 15 is formed in the shape of a rod lens 55. As a result of configuring the guide element 15 as a rod lens 55, the laser beam 11 used is focused, which means that an even more precise printed dot can be produced. The resolution of the print becomes finer and it is thus possible for an improved printing quality to be produced. Here, the rod lens 55 can assume any suitable lens shape which is necessary to focus the laser 11.

In every embodiment of the printing machine 1, when a laser 11 is used as the energy for transferring the ink, it is preferred for the focal point to be located on the interface between the flexible carrier 3 and the ink. In order to lead the laser 11 through the flexible carrier 3, it is necessary to configure the flexible carrier 3 to be transparent to the laser 11 used.

Even if only one guide element 15 is used, it is advantageous if this can be moved in the radial direction, in order for example to be able to adjust the printing gap. Furthermore, it is also advantageous, in particular if the device for the introduction of energy, for example the laser 11, can be moved together with the flexible carrier 3 or can be moved counter to the transport direction of the flexible carrier 3, if the guide element 15 also follows the movement of the laser 11.

Both solid bodies and hollow bodies can be used as a guide element 15 or, respectively, as first guide element 15.1 and second guide element 15.2. If hollow bodies are used, the wall thickness is chosen such that the guide element 15, 15.1, 15.2 does not deflect.

### LIST OF DESIGNATIONS

1 Printing machine
3 Flexible carrier
5 Deflection roller
7 Substrate
9 Printing area
11 Laser
13 Tensioning device
15 Guide element
15.1 First guide element
15.2 Second guide element
17 Transport direction of the flexible carrier 3
19 Printing gap
21 Application device
23 Applicator roll
25 Backing roll
27 Inking roll
29 Inking plate
31 Drip catcher
33 Storage container
35 Solvent container
37 Stirrer mechanism
39 Circulating pump
41 Feed line
43 Return line
45 Viscometer
51 Tensioning roller
53 Air cushion
55 Rod lens

1-17. (canceled)

18. A printing machine, comprising a flexible carrier which is coated with an ink to be printed, and further comprising a device for the introduction of energy into the ink, the device for the introduction of energy being arranged in such a way that the energy can be introduced in a printing area on a side of the flexible carrier facing away from the ink, so that ink is transferred from the carrier to a substrate to be printed, wherein in the printing area there is formed a printing gap between the flexible carrier and the substrate and there is arranged a tensioning device, which creates tension for the flexible carrier in the area in which the energy is introduced, in order to obtain a smooth surface.

19. The printing machine according to claim 18, wherein the tensioning device comprises at least two guide elements, which are arranged on the two sides of the device for the introduction of energy.

20. The printing machine according to claim 19, wherein the guide element is a tensioning roll, an air cushion or a non-moving rod.

21. The printing machine according claim 18, wherein the tensioning device comprises a guide element that is transparent to the energy introduced.

22. The printing machine according to claim 21, wherein the guide element that is transparent to the energy introduced is a body that is transparent to laser radiation, the body being formed in such a way that penetrating laser light is not scattered.

23. The printing machine according to claim 20, wherein the guide element that is transparent to the energy introduced is configured in such a way that the energy introduced is focused at a point on the flexible carrier.

24. The printing machine according to claim 18, wherein the device for the introduction of energy into the ink is a laser.

25. The printing machine according to claim 18, wherein the flexible carrier is transparent to the energy introduced.

26. The printing machine according to claim 18, wherein the flexible carrier is a circulating belt.

27. The printing machine according to claim 18, wherein an application device applies the ink to the flexible carrier.

28. The printing machine according to claim 18, wherein a device removes the ink from the flexible carrier.

29. A method for printing a substrate, comprising:
applying an ink to a flexible carrier, and
transferring the ink from the flexible carrier to the substrate in accordance with a predefined pattern, by introducing energy into the ink through the flexible carrier, some of the ink evaporating in the area of action of the energy and, as a result, a drop of ink being thrown onto the substrate to be printed,
wherein there is formed a printing gap between the flexible carrier and the substrate and tension is created for the flexible carrier in the area in which the energy is introduced into the ink.

30. The method according to claim 21, wherein the flexible carrier is a circulating belt and ink not transferred to the substrate is removed from the flexible carrier again.

31. The method according to claim 29, wherein the flexible carrier is guided over at least one guide element in order to create tension for the flexible carrier.

32. The method according to claim 29, wherein the flexible carrier is guided over at least two guide elements in order to create tension for the flexible carrier, the guide elements being arranged in the direction of movement of the carrier before and after the area in which the energy is introduced.

33. The method according to claim 29, wherein the flexible carrier is guided over a guide element, through which the energy is led and which is transparent to the energy introduced.

34. The method according to claim 33, wherein the energy introduced is focused to a point in the guide element that is transparent to the energy introduced.
